(19) United States
(12) Patent Application Publication
(10) Pub. No.: US 2018/0326329 A1
(43) Pub. Date: Nov. 15, 2018

(54) Method and Apparatus for Flushable Filter System

(71) Applicant: Nephros Inc., South Orange, NJ (US)

(72) Inventors: Gregory Collins, Monroe, NY (US); Daron Evans, Woodside, CA (US); Michael Milman, Brooklyn, NY (US)

(21) Appl. No.: 15/976,131

(22) Filed: May 10, 2018

Related U.S. Application Data
(60) Provisional application No. 62/503,982, filed on May 10, 2017.

(51) Int. Cl. B01D 29/66; B01D 29/52; B01D 65/02; B01D 29/11

(52) U.S. Cl. CPC B01D 29/668; B01D 29/114; B01D 65/02; B01D 29/52

(57) ABSTRACT

A flushable filter system is configured to purify a contaminated liquid containing substances that degrade filter performance and includes a filter cartridge including semi-permeable hollow fiber membrane that separates the filter cartridge into an upstream compartment and a downstream compartment. The system includes a flush port in communication with the upstream compartment of the filter cartridge for periodically discharging accumulated particulates and contaminates from an upstream side of the semi-permeable hollow fiber membrane. A device is provided to reduce mechanical stress imposed on the semi-permeable hollow fiber membrane during operation of the flushable filter system resulting in maintenance of integrity of the semi-permeable hollow fiber membrane during extended use and cyclic operation of the filter cartridge. The device is configured to dampen any fluid pressure spike that is observed within the flushable filter system during operation thereof.

### CROSS REFERENCE

The present application claims the benefit of and priority to U.S. provisional patent application Ser. No. 62/503,982, filed May 10, 2017, which is hereby incorporated by reference in its entirety.

### TECHNICAL FIELD

The present application is directed to a liquid purification filter system for use in a harsh environment that may include one or both of the following: (a) high levels of particulates that can plug the pores of the semi-permeable filter membrane used in the filter system that can result in a loss of filter performance over time; and (2) repetitive ON/OFF cycling of the filter system that creates pressure spikes (e.g., water hammer effects) that can result in a loss of filter integrity.

### BACKGROUND

Many filter devices are available commercially and generally include a semi-permeable filter membrane which removes contaminates, such as particulates, macromolecules, or other organic materials, by a size exclusion method. Filter membranes can be made with many different materials and in different configurations, such as flat sheets or hollow fibers. One advantage of using hollow fiber membranes is that one can incorporate a larger membrane surface area in a given filter space or volume, and as such, can result in a more efficient filter system where size may be a constraining factor. With hollow fiber membranes, however, they can be more prone to rupture or collapse when the pressure differential across the membrane exceeds certain limits. As these membranes become fouled with particulates, etc. this places more stress on the membrane as a higher pressure differential is required to filter fluid at a given rate. In situations where the unfiltered fluid contains high levels of particulates, macromolecules, or other organic materials, the filter will become fouled more quickly and require more frequent replacement. Further, if the filter is used in an area where there is a cyclic demand of purified fluid, such as repetitive turning ON and OFF of the water flow at a faucet or valve, this can result in pressure spikes and pressure differentials that exceed those when flow is continuous through a phenomena known as the “water hammer” effect. The combination of these two factors can then lead to situation whereby the one or more of the hollow fiber filter membranes may rupture prematurely, which renders the filter unusable and inadequate if continuing to rely on it to produce a purified fluid.

There is therefore a need to provide a purification filter system that more effectively works in harsh conditions having high levels of substances that can plug the pores of these membranes or in areas that have repetitive ON/OFF cycling which results in a shock wave of pressure spikes that can damage the semi-permeable hollow fiber membrane making it unusable.

### SUMMARY

To overcome the above difficulties of purifying a liquid in harsh conditions, a flushable filter purification system is disclosed whereby a flush port is incorporated as part of the upstream filter compartment of a filter device and is in fluid communication with a flush valve mechanism such that the accumulation of particulates, macromolecules, and/or other organic materials that plug the pores of the filter membrane in the upstream compartment can be effectively purged out of the filter device as a means to reduce the mechanical stresses being applied to filter membrane and further lengthen the life of the filter. For those situations where flow cycles ON and OFF and cause high pressure spikes, several embodiments of the invention actively reduce the magnitude of these pressure spikes by operation of the flush valve at these critical times. The teachings of the present invention thus provide mechanisms/devices that in effect provide a dampening effect on the pressure spikes, thereby greatly increasing the lifespan of the membrane. In other words, and as discussed herein, the amplitude of the pressure spikes are controlled and dampened in accordance with the teachings of the present invention which results in a reduction of the forces being exerted on the fiber membrane which over time results in degradation and shortened life span for the fiber membrane. The number of flush operations performed and duration are dependent at least in part on the quality of the water in that poorer water quality typically requires additional flush operations to be performed over a period of time, such as daily.

In a first embodiment, the flush valve is an electronically controlled valve that is coupled to a control unit that opens the flush valve at a fixed frequency (e.g., at least once daily) for a fixed period of time (e.g., at least five seconds). In a second embodiment, a pressure sensor that monitors the upstream compartment pressure has been added and sends a signal to the control unit to open the flush valve for a fixed period of time when the upstream pressure exceeds a pre-defined limit. In a third embodiment, a differential pressure sensor that monitors the differential pressure between the upstream compartment and the downstream compartment has been added and sends a signal to the control unit to open the flush valve for a fixed period of time when the differential pressure exceeds a pre-defined limit. In a fourth embodiment, a flow indicator device placed in either the inlet fluid stream or outlet fluid stream has been added and sends a signal to the control unit to open the flush valve for a fixed period of time when a change of flow rate exceeds a pre-defined limit. In a fifth embodiment, an inductive based current indicator device placed to detect the current used to operate a solenoid valve that turns ON or OFF through the filter system has been added and sends a signal to the control unit to open the flush valve for a fixed period of time when a change of current exceeds a pre-defined limit. In a sixth embodiment, a water hammer arrestor has been added to be in fluid communication with at least one of the upstream and downstream compartments of the filter as a means absorb pressure spikes caused by opening and closing of inlet or outlet valves. In a seventh embodiment, a water hammer transfer device that includes a moveable piston mechanism has been added whereby the moveable piston mechanism directly transfers pressure from the upstream compartment to the downstream compartment, and vice versa as a bypass mechanism to minimize mechanical stresses across the filter membrane when flow is suddenly stopped or started. In an eighth embodiment, a water hammer transfer device that includes a moveable piston mechanism that can be sensed by a position sensor is included. Similar to the seventh embodiment, the water hammer transfer device will transfer pressure between the upstream and downstream compartments as way to reduce the transmembrane pressure across the filter membrane, however, inclusion of a positional sensor to detect the location of the internal piston mechanism is used send a signal to the control unit to open the flush valve for a fixed period of time when the displacement distance meets a pre-defined limit.

### BRIEF DESCRIPTION OF DRAWINGS

FIG. 1 is a side perspective view of a purification system including a filter device with a flush port, a flush valve and a control unit in accordance with one embodiment;

FIG. 2 is a side perspective view of a purification system including a filter device with a flush port, a flush valve, a pressure sensor, and a control unit in accordance with one embodiment;

FIG. 3 is a side perspective view of a purification system including a filter device with a flush port, a flush valve, a differential pressure sensor, and a control unit in accordance with one embodiment;

FIG. 4 is a side perspective view of a purification system including a filter device with a flush port, a flush valve, a flow indicator, and a control unit in accordance with one embodiment;

FIG. 5 is a side perspective view of a solenoid valve operated purification system including a filter device with a flush port, a flush valve, an inductive current indicator used to detect status of solenoid valve, and a control unit in accordance with one embodiment;

FIG. 6 is a side perspective view of a purification system including a filter device with a flush port, a flush valve, a water hammer arrestor, and a control unit in accordance with one embodiment;

FIG. 7 is a side perspective view of a purification system including a filter device with a flush port, a flush valve, a dual sided water hammer transfer device, and a control unit in accordance with one embodiment;

FIG. 8 is a side perspective view of a purification system including a filter device with a flush port, a flush valve, a dual sided water hammer transfer device containing a piston position sensing device, and a control unit in accordance with one embodiment; and

FIG. 9 is a graph comparing operation of a filter system that has no flush port and one which has a flush port which is used to flush the filter system at a timed interval or in response to a detected event, with the graph plotting the flow rate to volume of liquid filtered before failure of the filter membrane.

### DETAILED DESCRIPTION OF PREFERRED EMBODIMENTS

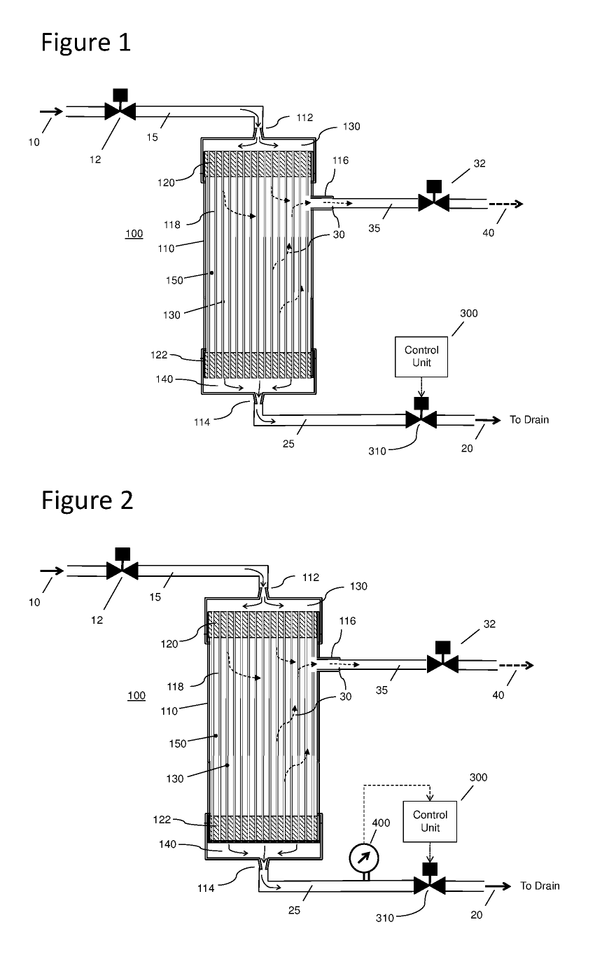

In the first embodiment (FIG. 1), a filter unit 100 is shown as is known in the art which removes unwanted particulates, macromolecules, and/or other organic materials by size exclusion based on the pore size of the filter membrane. The filter unit 100 is generally composed of the filter housing 110 and contains an inlet port 112 for receiving an unpurified liquid such as water and an outlet port 116 for delivering the purified liquid after passing through the filter unit. The filter unit 100 also includes a flush port 114 which is used to periodically purge the upstream compartment of the filter unit to remove accumulated materials which builds up during operation of the filter unit. The filter unit 100 contains a filter element 118 which can include a bundle of semi-permeable hollow fiber membranes (i.e., a plurality of hollow fibers) that are potted at each end (120 and 122) of the hollow fibers inside the filter housing and thus forms a first header space 130 at the inlet port end of the filter device and a second header space 140 at the flush port end of the filter device. The filter device is operated such that unpurified liquid 10 flow through a conduit 15 which leads to the inlet port 112. An inlet valve 12 may be used to control the flow of unpurified liquid into the filter unit 100 which may be based upon its availability or the demand of purified fluid. Unpurified liquid then enters the inlet header space 130 and flows into the upstream side of the semi-permeable hollow fiber membranes 130. An “upstream compartment” or “upstream space” is one which is upstream of the filter membrane and thus includes first header 130, the second header 140, and inside of the hollow fibers as wells as along the inlet conduit 15.

A flush port valve 310 is positioned at the flush port end to prevent fluid from exiting through a conduit 25 connected to the flush port 114. It will be appreciated that the conduit 25 is in fluid communication with the upstream side of the hollow fibers 130 (and 140) and thus, fluid pressure within the conduit 25 is representative of the upstream fluid pressure. With the flush port valve 310 closed, the unpurified liquid is filtered across the semi-permeable hollow fiber membrane and flows into a downstream compartment 150 of the filter unit. The filtered liquid 30 then flows out through the outlet port 116 which is in fluid communication with conduit 35. An outlet valve 32 may also be used to control the flow purified liquid out of the filter unit which may be based on the required downstream demand of the purified liquid. It is recognized that flow through the filter is driven by a pressure differential across the filter membrane and that as the membrane becomes fouled with materials that are being removed by the filter membrane, the mechanical stresses experienced by the membrane are generally increased. The result of these increased mechanical stresses is that there can be a premature failure of the filter membrane, such as a rupture of one or more of the hollow fiber membranes. Because the filter is based on a size exclusion principle, any loss of filter integrity results in a loss of effectiveness. For example, if the filter is being used to remove bacteria, a loss of filter integrity would result in bacteria being present downstream which could cause an adverse and/or unexpected condition if it were to go unnoticed. To avoid and/or minimize the stress conditions that may negatively impact the filter membrane integrity, a control unit 300 is used to control the opening and closing of the flush port valve 310. Frequency and timing for how long the flush valve remains opened is set by the control unit 300 and may be adjustable based on the contaminate levels of the fluid being filtered. Upon opening the flush valve 310, flow of the liquid from the upstream compartment of the filter unit flows into the second header compartment 140 and through the conduit 25 which is connected to the flush port 114 of the filter unit. Upon passing through the flush valve 310, the flushed liquid 20 is directed to a suitable drain fixture. It will be appreciated that the liquid that is used to flush the system by passing through hollow fibers is not purified water but instead is unpurified water which is in contrast to typical reverse type flushes.

It is also recognized that cyclic use of the filter unit causes additional mechanical stresses on the filter membrane. For example, upon closing the outlet valve 32 in a pressure driven system will result in a transient pressure spike due to conservation of momentum of the flowing stream. The pressure spike sets up a shock wave which travels back to the filter membrane and further contributes additional mechanical stresses not normally observed. In combination with the membrane becoming fouled by accumulation of contaminating substances, the stresses at the membrane level are further increased and thus more prone to early failure. It should then be understood by those skilled in the art, that periodic flushing of these contaminates thus serves to extend the life of the filter, in particular in harsh conditions with high levels of contaminate and cyclic operation of the filter.

Thus, a pressure spike can occur when the outlet valve 32 closes quickly and there is insufficient time for the feed water device (e.g., a pump, regulator, or combination) to self-adjust to the preset inlet pressure; or, alternatively, a pressure spike can result when the feed water device (e.g., a pump) ramps up too quickly due to inefficiency in control/adjustment as a result of water pressure changing quickly when other outlets in the main system are opened or closed.

According to a second embodiment of the invention as shown in FIG. 2, a pressure sensor 400 has been added to the flush port conduit 25 as a means to monitor pressure changes occurring in the upstream side of the filter compartment. If due to membrane fouling or cycling of the inlet or outlet valves, 12 and 32 respectively, a high pressure condition or pressure spike can occur. If the pressure is sensed to be above a predefined limit or threshold, a signal from the control unit 300 is sent to open the flush port valve 310 for a set period of time necessary to flush a portion of the accumulated fluid particulates out to the drain. The effect of this is to prevent high pressure conditions and resulting mechanical stresses that can damage the filter membrane.

In at least one embodiment, the predefined limit or threshold is an at least 15 psi increase in the upstream side pressure and in another embodiment, the predefined limit or threshold is at least 30 psi increase in the upstream side pressure. In at least one example, the incoming unpurified liquid has a pressure of between about 60 psi and about 100 psi and more preferably between 60 psi and 80 psi. For incoming water pressures in this range, the pressure spike can be maintained to be less than 30 psi, preferably below 25 psi, preferably below 20 psi and in one embodiment, below 15 psi. Thus, when the incoming fluid pressure is at 60 psi and the pressure spike is 30 psi, the observed upstream fluid pressure is 90 psi (60 psi (normal)+30 psi (spike)). As described herein, in the event that upstream side pressures are detected greater than one of these thresholds, remedial action is taken in that the flush port valve 310 is opened to alleviate such upstream side pressure build-up (pressure spike).

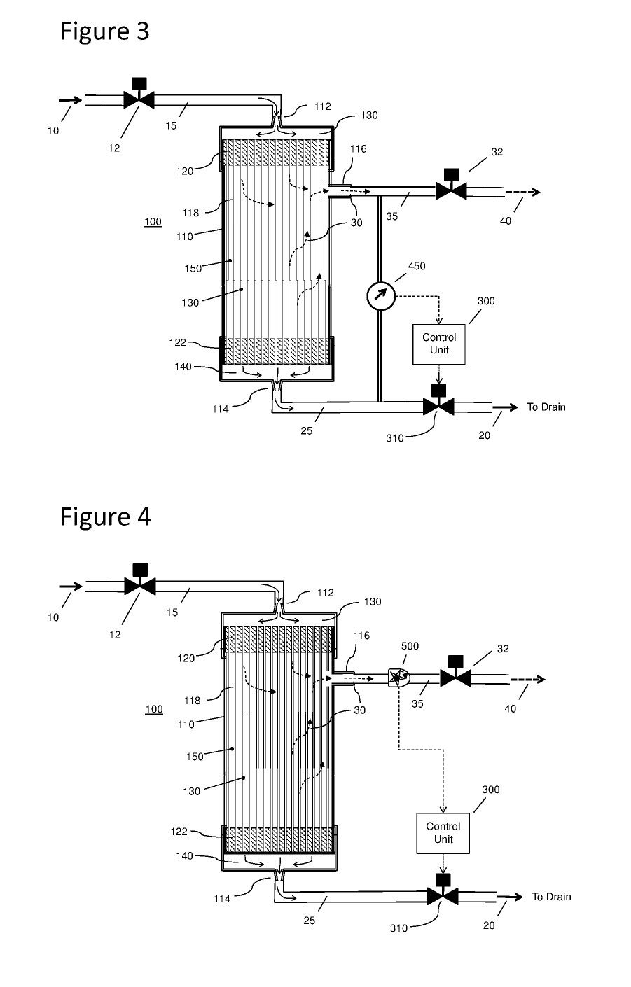

According to a third embodiment of the invention, as shown in FIG. 3, a differential pressure sensor 450, as known in the art, is positioned to monitor the difference in pressure between the upstream and downstream compartments of the filter 100. In FIG. 3, one side is in fluid communication with the purified outlet conduit 35 while the other side is in fluid communication the flush port conduit 25. It is understood to those skilled in the art that one could also position the differential pressure sensor monitor pressure in the inlet conduit 15 as an alternative to the flush port conduit 25 to achieve the same effect. It is also understood by those skilled in the art that the differential pressure is directly related to the transmembrane pressure across semi-permeable filter membrane. Similar to that described above, a high pressure condition or pressure spike can occur if the flow is turned ON or OFF by opening or closing the inlet or outlet valves. If the differential pressure is sensed to be above or below a predefined limit or threshold, a signal from the control unit 300 is sent to open the flush port valve 310 for a set period of time necessary to flush a portion of the accumulated fluid particulates out to the drain. The effect of this is to prevent high transmembrane pressure conditions and resulting mechanical stresses that can damage the filter membrane. In at least one embodiment, the flush port valve 310 can be opened when a differential pressure that relates to a pressure spike of greater than 30 psi, preferably greater than 25 psi, preferably greater 20 psi and in one embodiment, greater than 15 psi.

Communication between the sensor 450 and the control unit 300 can be achieved using traditional techniques and protocol, such as a wired connection or wireless connection.

According to a fourth embodiment of the invention as shown in FIG. 4, a flow sensor 500, as known in the art, is positioned to monitor the flow of purified liquid passing through the filter 100. In FIG. 4, the flow sensor is positioned to monitor flow of purified liquid in conduit 35, however, it is understood to those skilled in the art that one could also position the flow sensor in the inlet conduit 15 as an alternative to achieve the same effect. It is also understood by those skilled in the art that pressure spikes occur when flow is suddenly stopped as momentum must be conserved. For example, this occurs when one of the flow control valves, such as the inlet valve 12 or the outlet valve, 32 is suddenly closed and causes a condition more generally known as the water hammer effect. To minimize the pressure spikes associated with this water hammer effect, flow changes are sensed such that a signal from the control unit 300 is sent to open the flush port valve 310 for a set period of time when a change in flow rate above or below a predefined limit or threshold is detected. In a manner similar to described above, this temporary diversion of fluid through the flush valve will both minimize the pressure spikes occurring from the water hammer effect and also allow a portion of the accumulated fluid particulates to be flushed out of the upstream compartment and out to drain, the net effect being to reduce mechanical stresses that can damage the filter membrane.

In at least one embodiment, the flush port valve 310 can be opened when, according to one embodiment, a change in flow that can be equated to an upstream side pressure spike of greater than 30 psi, preferably greater than 25 psi, preferably greater 20 psi and in one embodiment, greater than 15 psi is detected.

Communication between the sensor 500 and the control unit 300 can be achieved using traditional techniques and protocol, such as a wired connection or wireless connection.

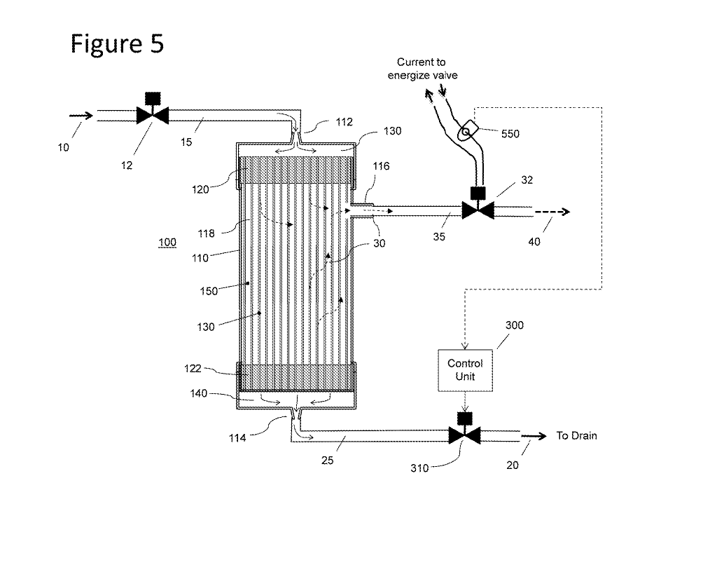

According to a fifth embodiment of the invention as shown in FIG. 5, an induction based current sensor 550, as known in the art, is positioned to monitor the flow of electrical current being applied to operate the outlet valve 32 (which comprises an electronic valve). This can achieve the same result as the fourth embodiment provided that flow is controlled by an electronically controlled valve. In other words, opening and closing the outlet valve 32 is directly related to starting and stopping of flow through the filter unit. An example of where an electronically controlled valve might be used is in an ice machine application where purified water is required for a time period necessary to fill up a tray for making ice. In FIG. 5, the induction based current sensor is positioned to monitor current used to operate the outlet valve 32, however, it is understood to those skilled in the art that one could also position the induction based current sensor on the inlet valve 12 as an alternative to achieve the same effect. The advantage of this method over the use of a flow sensor is that it does not require installation of a component directly into the fluid stream.

By directly monitoring the state of the outlet valve 32, the control unit 300 can instruct opening of the valve 310 to avoid undesirable pressure spikes that can occur for the reasons discussed herein. In this manner, the opening of valve 310 is controlled by feedback received concerning the operating state of the outlet valve 32. This allows pressure spikes to be dampened as discussed herein.

Communication between the sensor 550 and the control unit 300 can be achieved using traditional techniques and protocol, such as a wired connection or wireless connection.

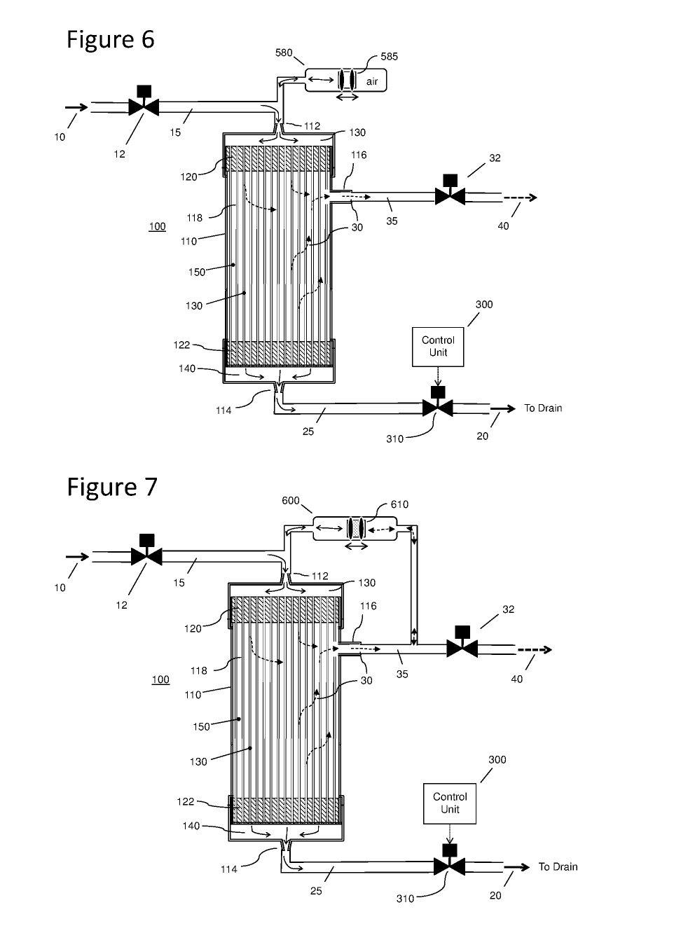

According to a sixth embodiment as shown in FIG. 6, a water hammer arrestor device 580 is incorporated in the system such that it is in fluid communication with the upstream compartment, inlet conduit 15. Internal to the water hammer arrestor device 580 is a moveable piston 585 that seals against the inside wall of the arrestor device (the housing 580 thereof) and thus prevent fluid from entering the chamber side filled with air. As shown, the arrestor device 580 is in fluid communication with the inlet conduit 15 and in particular a T-shaped fluid path can be provided with flow from the inlet conduit 15 flowing to both the arrestor device 580 and the filter device.

Operation is such that during a sudden change in flow, a transient pressure spike, or water hammer, may originate in either the upstream compartment or the downstream compartment of the filter device. When this occurs, fluid will enter the arrestor device 580 (via the conduit leading thereto) and move the piston 585 in a direction that compresses the air in the sealed chamber. This effectively acts as a cushion to absorb the transient pressure spike that occurs as part of the water hammer effect. Because the high pressure spike is being temporarily absorbed by the air cushion of the arrestor device, the effect is to reduce the transmembrane pressure occurring across the filter membrane. It should be understood to those skilled in the art that pressure spikes can be both positive and negative depending upon flow direction and configuration of the valve as being upstream or downstream of the flow during closure. Use of a water hammer arrestor device with a filter device containing a semi-permeable hollow fiber membrane is not obvious since pressure spikes can originate from different directions. Therefore, placement of more than one water hammer arrestor device 580 may be necessary to adequately prevent transmembrane spikes being transferred across the filter membrane of the filter device.

According to a seventh embodiment as shown in FIG. 7, a dual sided water hammer transfer device 600 is added such that one side is in fluid communication with the upstream compartment, inlet conduit 15, while the other side is in fluid communication with the downstream compartment, outlet conduit 35. Internal to the water hammer transfer device is a moveable piston 610 that seals against the inside wall of the transfer device and thus prevents mixing of unpurified liquid 10 with purified liquid 40. Operation is such that during a sudden change in flow, a transient pressure spike, or water hammer, may originate in either the upstream compartment or the downstream compartment of the filter device. If for example this occurs in the downstream compartment due to closure of the outlet valve 32, the sudden increase in pressure will push purified water into the right side of the transfer device 600 (via the conduit from the outlet conduit 35 to the right side of the transfer device 600) and will displace the piston 610 to the left. As this occurs, unpurified fluid contained on the left side of the transfer device 600 will be pushed out and into the inlet conduit 15, with the net effect to increase the inlet side pressure. The advantage of this mechanism is that it enables a temporary bypass of fluid pressure between the downstream and upstream compartments in a way that avoids being transferred directly as a transmembrane pressure across the filter membrane. Since liquids are relatively incompressible relative to air, this may be a more effective way to minimize transmembrane spikes at the filter membrane level. Though not shown, springs may be included inside the transfer device as a means to center the piston member during normal operation of the filter. In other words, the one or more springs act as a return mechanism to return the piston member to the center of the transfer device.

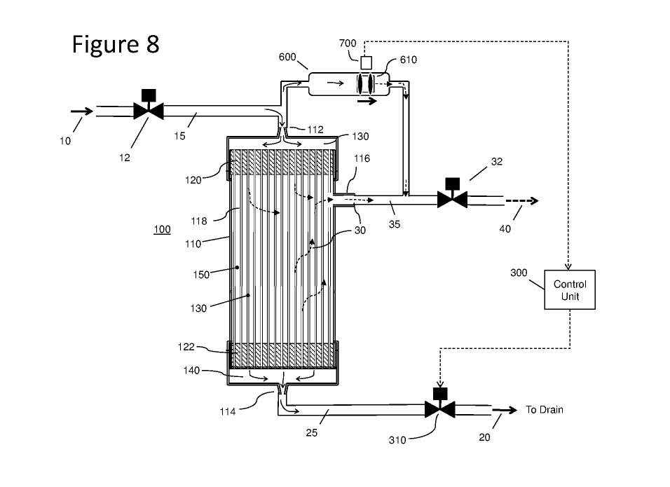

In an eighth embodiment as shown in FIG. 8, the water hammer transfer device 600 with its moveable piston mechanism 610, also includes a position sensor 700 that is capable to detect the position of the moveable piston mechanism 610. With respect to transferring pressure between the upstream and downstream compartments, operation is similar to the sixth embodiment. The advantage, however, of adding the position sensor 700 to the water hammer transfer device 600, is that it can be used as a control input to control unit 300 that can send a signal to open the flush valve 310 for a fixed period of time. As an example, upon opening the inlet valve 12, a sudden increase in pressure will occur in the inlet conduit 15. This will force unpurified fluid into the left side of the transfer device 600 and push the moveable piston 610 toward the right side. This will in turn force purified fluid into the outlet conduit 35 and temporarily increase the pressure there as way to minimize the transmembrane pressure being applied across the filter membrane. In addition to the above, when the piston 610 is detected to be displaced a pre-defined distance, a signal from the control unit is used to open the flush valve 310 for a fixed period of time as a means to flush a portion of the accumulated fluid particulates out to the drain. The overall effect of this is to prevent high transmembrane pressure conditions and resulting mechanical stresses that can damage the filter membrane.

Thus, the embodiment of FIG. 8 offers the advantage that feedback from the transfer device 600 is delivered to the control unit 300 to control operation of the valve 310. In other words, the transfer device 600 indirectly reads the upstream fluid pressure by monitoring the operating state of the transfer device 600.

The following example is only exemplary and not limiting of the scope of the present invention.

### Example 1

A system as disclosed in FIG. 6 or FIG. 7 is provided and an unpurified water stream is delivered through the inlet conduit at a pressure of between 60 psi and 100 psi and more particularly, has a pressure of about 60 psi. The fluid arrestor device is configured such that it dampens any pressure spikes that occur in the system and more particularly, any pressure spikes that occur in the system are dampened such that they are no greater than 30 psi or no greater than 25 psi or no greater than 20 psi or no greater than 15 psi (relative to the upstream pressure of the system).

Pressure spikes can be thought of as being a delta between the intended target system pressure (such as 60 psi) and a maximum recorded pressure in the system (such as 90 psi) which in this example would be a pressure difference or spike of 30 psi (90 psi-60 psi).

By controlling the amplitude of any pressure spikes that are recorded in the system, the integrity of the filter device is improved and the lifespan of the filter device is significantly lengthened. As described herein, the pressure spike can be transmitted from the upstream compartment of the filter device to the downstream compartment or alternatively, the pressure spike can be transmitted from the downstream compartment to the upstream compartment. As described herein, the present invention is configured to dampen such pressure spikes regardless of whether they are transmitted from the upstream compartment to the downstream compartment or from the downstream compartment to the upstream compartment. In any event, the pressure spike can be detected by monitoring the pressure in the upstream side of the filter device.

### Example 2

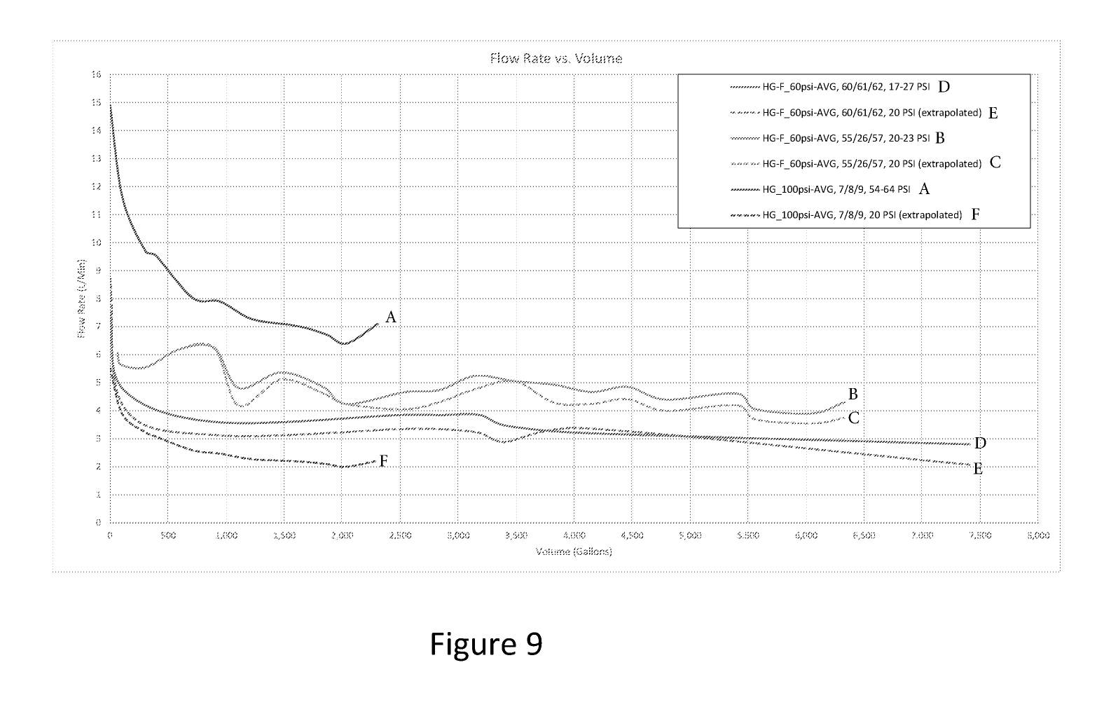

Table 1 set forth below and FIG. 9 illustrate the benefits obtained by the present invention in which a fluid flush operation is performed as part of normal operation of the filter system. In particular, Table 1 includes data of a filter cartridge as illustrated in the present application being operated without a flush operation (top box) and with a flush operation (bottom box). The flush was performed every 16 cycles which corresponded to 1 flush per 1 day and the flush lasted about 5 seconds. Every 1000 cycles, the filter device was checked to monitor fiber integrity and in the event that at least one fiber broke, the experiment was completed and the filter device taken off-line. As can be seen from the test data, incorporation of a flush operation greatly extended the life of the filter device. It will be understood that a flush operation entails opening of the flush port 310.

TABLE 1
Summary of Cyclic Fatigue Testing for the HydraGuard
10″ vs. HydraGuard 10″ - Flush

| | HydraGuard 10″ | |
|---|---|---|
| | Cyclic Fatigue at 100 psi | |
| Filter ID#/Lot# | Cycles Completed* | Gallons Filtered* |
| 10IF-17-007/PI16-0691 | 4,125 | 1198 |
| 10IF-17-008/PI16-0690 | 7,200 | 1910 |
| 10IF-17-009/PI16-0690 | 7,200 | 2101 |
| 10IF-17-010/2021-2016 | 5,670 | 1354 |
| 10IF-17-011/PI16-0691 | 4,350 | 1175 |
| 10IF-17-012/2021-2016 | 5,670 | 1608 |
| 10I-17-015/PI16-0690 | 3,260 | 1175 |
| 10I-17-016/PI16-0690 | 3,260 | 1265 |
| 10I-17-017/PI16-0691 | 3,260 | 1299 |
| Average | 4,888 | 1,454 |

HydraGuard 10″- Flush
Cyclic Fatigue at 60 psi

| Filter ID#/Lot# | Cycles Completed* | Gallons Filtered* |
|---|---|---|
| 10I-17-055/PI17-0315 | 18,987 | 6559 |
| 10I-17-056/PI17-0315 | 18,987 | 6177 |
| 10I-17-057/PI17-0315 | 18,987 | 6251 |
| 10I-17-060/PI17-0533 | 16,780 | 8202 |
| 10I-17-061/PI17-0533 | 10,300 | 4571 |
| 10I-17-062/PI17-0533 | 16,780 | 6985 |
| Average | 16,804 | 6,458 |
| Improvement | 344% | 444% |

FIG. 9 shows similar data in that the filter devices operated at 60 psi, controlled for incoming pressure spikes above 60 psi, included a flush operation (1× a day for 5 seconds), while the filter devices operated at 100 psi, a simulation of constant pressure spikes of 40 psi, did not include a flush operation. As can be seen, those filter devices that were operated with a flush operation and controlled for pressure spikes lasted substantially longer than the filter device that was operated without a flush operation and simulated with 40 psi pressure spikes (i.e., the number of gallons flushed is far greater before failure of the filter membrane).

It should be understood that this invention is not intended to cover the specifics around the filter element and/or filter unit design, but rather an added feature that extends the use of the filter unit in harsh conditions which includes cyclic operation and/or high levels of contaminates which foul the filter membrane. What is important to understand with respect to the configuration of the filter unit 100 is that it contains an inlet port 112 for receiving unpurified liquid, an outlet port 116 for delivery of the purified liquid, and a flush port 114 that is in fluid communication with the upstream compartment of the filter unit whereby accumulated sediment can be purged out of the upstream compartment. As such, the filter unit can be constructed as a single unit having a disposable filter housing, or a filter cartridge that is inserted inside a reusable filter housing.

What is claimed:

1. A flushable filter system configured to purify a contaminated liquid containing substances that degrade filter performance and/or is operated cyclically depending upon downstream demand, said flushable filter system comprising:
a filter cartridge including semi-permeable hollow fiber membrane that separates the filter cartridge into an upstream compartment and a downstream compartment;
an inlet port in communication with the upstream compartment of the filter cartridge for receiving unpurified liquid that is to be purified;
an outlet port in communication with said downstream compartment of the filter cartridge for discharging purified liquid;
a flush port in communication with the upstream compartment of the filter cartridge for periodically discharging accumulated particulates and contaminates from an upstream side of the semi-permeable hollow fiber membrane; and
a device configured to reduce mechanical stress imposed on the semi-permeable hollow fiber membrane during operation of the flushable filter system resulting in maintenance of integrity of the semi-permeable hollow fiber membrane during extended use and cyclic operation of the filter cartridge, wherein the device is configured to dampen any fluid pressure spike that is observed within the flushable filter system during operation thereof.

2. The flushable filter system of claim 1, further including an inlet conduit that is in fluid communication with the inlet port and includes an inlet valve that is positionable between an open position and a closed position and an outlet conduit that is in fluid communication with the outlet port and includes an outlet valve; a flush port conduit that is in fluid communication with the flush port and includes a flush port valve that is positionable between an open position and a closed position; and a control unit that is operatively connected to the flush port valve for positioning the flush port valve between the closed position and the open position.

3. The flushable filter system of claim 1, wherein the device comprises a control unit and electronically controlled flush valve in fluid communication with the flush port that opens to discharge accumulated liquid contaminates from the upstream compartment at a set frequency for a set duration of time based on a signal from the control unit.

4. The flushable filter system of claim 1, wherein the device comprises a pressure sensor in fluid communication with the upstream compartment that senses pressure spikes and signals the control unit to open the flush valve for a set period of time when exceeding a pre-defined limit.

5. The flushable filter system of claim 2, wherein the device comprises a differential pressure sensor in fluid communication with the upstream compartment and downstream compartment and configured to sense transmembrane pressure spikes and to signal the control unit to open the flush port valve for a set period of time when exceeding a pre-defined limit.

6. The flushable filter system of claim 2, wherein the device comprises a flow indicator device positioned to detect flow of either the unpurified or purified liquid streams entering or leaving the filter device that signals a control unit to open the flush port valve for a set period of time when a change in flow exceeds a pre-defined limit.

7. The flushable filter system of claim 2, wherein the device comprises an induction-based current sensor positioned to detect electrical current applied to the outlet which comprises a solenoid valve that opens and closes to turn ON and OFF flow through the filter system that signals the control unit to open the flush port valve for a set period of time when a change in electric current exceeds a pre-defined limit.

8. The flushable filter system of claim 2, wherein the device comprises a pressure displacement device that has a first end in fluid communication with the inlet port, a second end in communication with the outlet port, a moveable internal piston member that prevents mixing of the unpurified liquid and the purified liquid at each end and is displaceable as a means to transmit a pressure spike from the upstream compartment to the downstream compartment and vice versa without contaminating the purified liquid.

9. The flushable filter system of claim 8, wherein the device comprises a position detector coupled to the pressure displacement device that senses when the moveable internal piston member is displaced a predetermined distance and signals the flush port valve to open for a set period of time.

10. The flushable filter system of claim 8, wherein the first end of the pressure displacement device is fluidly connected to a first conduit leg that is in fluid communication with the inlet conduit and a second conduit leg is connected to the inlet port from the inlet conduit, the inlet conduit, the first conduit leg and the second conduit leg being arranged in a T-shape with the first conduit leg and the second conduit leg being coaxial and formed perpendicular to a longitudinal axis of the inlet conduit.

11. The flushable filter system of claim 9, wherein the set period of time comprises at least 5 seconds.

12. The flushable filter system of claim 1, whereby the semi-permeable filter element comprises a plurality of hollow fiber filter membranes.

13. The flushable filter system of claim 8, wherein the first end of the pressure displacement device is fluidly connected to the inlet conduit via a first conduit and the second end of the pressure displacement device is fluidly connected to the outlet conduit via a second conduit.

14. The flushable filter system of claim 8, wherein the pressure displacement device is disposed upstream of the upstream compartment of the filter cartridge.

15. A method of extending the life of a purifying filter being used for filtration of fluid containing high levels of contaminates that foul a filter device that optionally operates in a cyclic manner, comprising the steps of:
supplying an unpurified fluid to an upstream compartment of the filter device;
filtering said unpurified fluid by passing it through a semi-permeable hollow fiber membrane of the filter device,
discharging purified fluid; and
flushing the upstream compartment for a set time period to remove accumulated contaminates by opening a flush port valve, whereby flushing the upstream compartment is initiated upon occurrence of at least one of the following events:
(a) time clock from a control unit signals flush valve to open;
(b) pressure in upstream compartment reaches a pre-defined limit;
(c) differential pressure across the semi-permeable hollow fiber membrane reaches a pre-defined limit;
(d) change in flow rate through the semi-permeable hollow fiber membrane reaches a pre-defined limit;
(e) change in electrical current supplied to the control valve reaches a pre-defined limit; and
(f) displacement of a piston member in a water hammer transfer device reaches a pre-defined limit.

16. The method of claim 15, wherein the unpurified fluid is delivered to the upstream compartment at a pressure of about 60 psi and the flush port valve is opened if a pressure difference of greater than 30 psi is observed across the semi-permeable hollow fiber membrane.

17. A flushable filter system used to purify a contaminated liquid containing substances that degrade filter performance and/or is operated cyclically depending upon downstream demand, said flushable filter system comprising:
an inlet conduit for delivering liquid to be purified;
an outlet conduit for discharging purified liquid;
a filter cartridge/housing with semi-permeable hollow fiber membrane that separates the filter into an upstream compartment and a downstream compartment;
an inlet port in communication with both the inlet conduit and the upstream compartment for receiving the liquid to be purified from the inlet conduit;
an outlet port in communication with the downstream compartment and the outlet conduit for discharging the purified liquid;
a flush port in communication with the upstream compartment for periodically discharging accumulated particulates and contaminates from an upstream side of the semi-permeable hollow fiber membrane by opening a flush port valve that is in fluid communication with the flush port and is located along a flush port conduit;
a water hammer arrestor device that is used to reduce the mechanical stress imposed on the semi-permeable hollow fiber membrane during use resulting in maintenance of filter membrane integrity during extended use, the water hammer arrestor device being in fluid communication with the inlet conduit and being located upstream of the inlet port of the filter cartridge; and
a control unit in communication with the flush port valve located in the flush port conduit.

18. The system of claim 17, wherein the water hammer arrestor device has a first end in fluid communication with the inlet port, a second end in communication with the outlet port, a moveable internal piston member that prevents mixing of the unpurified liquid and the purified liquid at each end and is displaceable as a means to transmit a pressure spike from the upstream compartment to the downstream compartment and vice versa without contaminating the purified liquid.
